(19) United States
(12) Patent Application Publication
(10) Pub. No.: US 2013/0286667 A1
(43) Pub. Date: Oct. 31, 2013

(54) LIGHT FIXTURES AND INSTALLATION METHODS THEREOF

(71) Applicants: Jeffrey B. Sampsell, Pueblo West, CO (US); Robert L. Holman, San Jose, CA (US); Matthew B. Sampsell, San Jose, CA (US)

(72) Inventors: Jeffrey B. Sampsell, Pueblo West, CO (US); Robert L. Holman, San Jose, CA (US); Matthew B. Sampsell, San Jose, CA (US)

(73) Assignee: QUALCOMM MEMS TECHNOLOGIES, INC., San Jose, CA (US)

(21) Appl. No.: 13/460,516

(22) Filed: Apr. 30, 2012

(51) Int. Cl. F21V 21/00; H02G 13/00

(52) U.S. Cl. 362/368; 52/741.1

(57) ABSTRACT

This disclosure provides systems, methods and apparatus for securing a light fixture in place. In one aspect, the light fixture can be configured to retain an LED-based light engine, which may be thinner and/or lighter than conventional light engines. In another aspect, the light fixture can be configured to be installed in a pre-cut aperture in a structural member, such as a ceiling, soffit, or wall. In another aspect, the light fixture may include a serrated upper edge configured to cut into a structural member to form an aperture, without the need to pre-cut the aperture.

### TECHNICAL FIELD

This disclosure relates to lighting fixtures, particularly for LED-based light engines, and installation methods thereof.

### DESCRIPTION OF THE RELATED TECHNOLOGY

Conventional lighting fixtures utilize incandescent or fluorescent lighting, and are generally at least several inches deep, and correspondingly bulky. Because of the size and weight of these fixtures, building codes and other practical considerations require securement of these fixtures directly to a frame or similar rigid structural member. When such light fixtures are to be installed within a false ceiling, or similar structure, installation requires securement not only to a suspended ceiling tile resting within a frame, but to the frame itself, or similar structure. These requirements increase the complexity of the installation and may constrain the placement of the light fixture within the suspended ceiling tile.

### SUMMARY

The systems, methods and devices of the disclosure each have several innovative aspects, no single one of which is solely responsible for the desirable attributes disclosed herein.

One innovative aspect of the subject matter described in this disclosure can be implemented in a self-anchoring light fixture, including a body portion configured to retain a light engine, a bezel removably coupled to a first side of the body portion, where the bezel permits light from the light engine to exit the light fixture through a central portion of the bezel, and a hollow cylindrical member extending from a second side of the body portion opposite the first side and having a cross-sectional diameter, where the cylindrical member includes a serrated upper edge.

In one aspect, the body portion can have a first cross-sectional dimension, and the hollow cylindrical member can have a cross-sectional diameter, where the cross-sectional diameter of the cylindrical member is less than the first cross-sectional dimension of the body portion. In one aspect, the cylindrical member can include a pilot drill extending upwards beyond the serrated upward edge of the cylindrical member and a support assembly supporting the pilot drill.

In one aspect, the cylindrical member can include a wiring adapter extending upward from the body portion along at least a portion of the height of the cylindrical member, where the wiring adaptor is configured to provide a conductive path between the light engine and an external power source. In one aspect, the cylindrical member can include a thread extending around an outer surface of the cylindrical member.

Another innovative aspect of the subject matter described in this disclosure can be implemented in a light fixture, including a body portion configured to receive a light engine and including a hollow cylindrical portion with at least one thread extending around a surface of the hollow cylindrical portion.

In one aspect, the fixture can additionally include a bezel extending around the perimeter of the body portion. In a further aspect, the hollow cylindrical portion can have a first diameter, and the bezel can have a second diameter, the second diameter being larger than the first diameter. In one aspect, an upper edge of the hollow cylindrical portion can be configured to cut into a wall or ceiling material during installation of the fixture. In one aspect, the body portion can include one or more receptacles adapted to receive portions of a drive tool to allow the light fixture to be rotated during installation of the fixture.

Another innovative aspect of the subject matter described in this disclosure can be implemented in a method of installing a light fixture, including providing a light fixture, the light fixture including a body portion configured to retain a light engine on a first side of the body portion, where the body portion has a first cross-sectional dimension, and a hollow cylindrical member extending from a second side of the body portion opposite the first side, and having a diameter, and where the cylindrical member includes a serrated upper edge, forming an aperture in a wall or ceiling by rotating the light fixture such that the serrated edge of the cylindrical member cuts through the wall or ceiling to form an aperture, and inserting at least a portion of the cylindrical member into the aperture.

In one aspect, the light fixture can additionally include a pilot drill extending upwards beyond the serrated upward edge of the cylindrical member and a support assembly supporting the pilot drill, where the pilot drill is configured to retain the light fixture in place during the rotation of the light fixture to form the aperture in the ceiling or wall. In one aspect, the method can additionally include securing a bezel to the first side of the body portion, where the bezel permits light from the light engine to exit the light fixture through a central portion of the bezel. In one aspect, the method can additionally include securing a light engine within the body portion of the fixture. In a further aspect, the method can additionally include connecting the light engine to a power source via wiring extending through the cylindrical member.

Another innovative aspect of the subject matter described in this disclosure can be implemented in a method of installing a light fixture, including providing a light fixture having a body portion configured to receive a light engine and a hollow cylindrical portion with at least one thread extending around a surface of the hollow cylindrical portion, and rotating the light fixture such that the thread engages the interior of an aperture formed in a wall or ceiling and at least a portion of the hollow cylindrical portion is inserted into the aperture.

In one aspect, the upper edge of the hollow cylindrical portion can be configured to cut into a wall or ceiling during installation of the fixture, and rotation of the hollow cylindrical portion also forms the aperture in the wall or ceiling by cutting into the wall or ceiling. In one aspect, the body portion of the light fixture can include one or more receptacles adapted to receive portions of a drive tool, and rotating the light fixture can include inserting portions of a drive tool into the receptacles in the body portion of the light fixture, and rotating the drive tool to cause rotation of the light fixture.

Another innovative aspect of the subject matter described in this disclosure can be implemented in a light fixture, including a body portion configured to receive an LED light engine and including a hollow cylindrical portion having means for retaining the light fixture relative to a structural member. In one aspect, the retaining means include at least one thread extending around a surface of the hollow cylindrical portion. In one aspect, the light fixture can additionally include means for forming an aperture within a structural member. In a further aspect, the forming means can include a serrated or sharp edge of the cylindrical portion.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1A is a cross-section perspective view of an implementation of a circular light guide that can be used to receive light from one or more centrally located light emitting diodes (LEDs).

FIGS. 1B and 1C illustrate cross-section perspective views of an implementation of a light engine including the circular light guide of FIG. 1A.

FIG. 1D illustrates an exploded schematic view of another implementation of a circular light guide plate with a light-turning film.

FIG. 1E shows a perspective view of an example of a light engine incorporating a light guide such as the light guides illustrated in FIGS. 1A-1D.

FIG. 1F shows another perspective view of the light engine of FIG. 1A.

FIG. 1G shows a perspective view of an example of a retention structure configured to retain the light engine of FIG. 1A.

FIG. 2 shows an example of a self-anchoring light-fixture configured to retain a light engine.

FIG. 3A shows an exploded view of another example of a self-anchoring light fixture configured to retain a light engine.

FIG. 3B shows a cross-section of the assembled light fixture of FIG. 3A after installation.

FIG. 4 shows an example of a self-anchoring light fixture which does not require a pre-cut aperture.

FIG. 5A shows an example of an exploded cross-section of a fixture configured to be installed within an aperture having a cross-sectional dimension less than the cross-sectional dimension of a retained light engine.

FIG. 5B shows an example of a cross-section of the assembled fixture of FIG. 5A.

FIG. 6A shows an example of a self-anchoring light fixture which includes additional features configured to facilitate installation of the light fixture.

FIG. 6B shows a cross-sectional view of the body portion of the light fixture of FIG. 6A, taken along the line 6B-6B.

FIG. 7 is a block diagram showing an example of a method of installing a self-anchoring light fixture.

FIG. 8 is a block diagram showing an example of another method of installing a self-anchoring light fixture.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. While the teachings are applicable to light fixtures for retaining thin LED-based light engines, and in particular LED-based light engines which include a light guide for directing the output of an LED-light source in a desired pattern, the teachings may also be applicable to any light fixtures configured to retain sufficiently light-weight and/or thin light engines. It is contemplated that the described implementations may be included in or associated with lighting used for a wide variety of applications such as, but not limited to: commercial, industrial, and residential lighting. Implementations may include but are not limited to lighting in homes, offices, manufacturing facilities, retail locations, hospitals and clinics, convention centers, cultural institutions, libraries, schools, government buildings, warehouses, military installations, research facilities, gymnasiums, sports arenas, or lighting in other types of environments or applications. In various implementations the lighting may be overhead lighting and may project downward a narrow spotlight or a spotlight having an area that is larger (for example, several times or many times larger) than an area of a light emitting surface of a lighting device. Thus, the teachings are not intended to be limited to the implementations depicted solely in the Figures, but instead have wide applicability as will be readily apparent to a person having ordinary skill in the art.

In some implementations, a lighting device or apparatus can include a light engine component and a connection portion for electrically and/or mechanically coupling the lighting device to a light fixture. As used herein, the term “light fixture” refers to any fixture or structure configured to be electrically and/or mechanically coupled to any portion of a lighting device, for example, a recessed light housing, a downlight fixture, a can fixture, a pot light fixture, a cove light fixture, a torch lamp fixture, a pendant light fixture, a sconce fixture, a track light fixture, and/or a bay light fixture, whether secured to a vertical surface such as a wall, a horizontal surface such as a ceiling, soffit, floor, table, or other structure.

Conventional lighting systems are bulky, and light fixtures configured to retain conventional lighting are similarly bulky and correspondingly heavy. When installed in structural members such as ceiling tiles, walls, or soffits the size and weight of conventional lighting fixtures require that the fixtures be secured to rigid structural members such as framing. In contrast, some light engines such as LED-based light engines can be made significantly more thin and/or light-weight than conventional lighting systems. For example, a light fixture configured to retain an LED-based light engine or similar light engine may weigh less than one pound installed, whereas conventional lighting fixtures may weigh more than 5 pounds, and may even weight as much as 50 pounds or more Such lighter fixtures can be safely secured to, for example, ceiling panels in false ceilings, without requiring further securement directly to frames or other more rigid structural members.

Particular implementations of the subject matter described in this disclosure can be implemented to realize one or more of the following potential advantages. By providing threads on the exterior of cylindrical portions of light fixtures configured to retain such light engines, self-anchoring light fixtures can be provided which can be easily installed in a wider variety of locations than light fixtures configured to retain traditional lighting systems. In addition, because the installation of such a fixture does not require additional securement to a frame or other rigid member, the installation of the fixtures can be substantially simplified, allowing cheaper and easier installation of lighting systems. Certain light fixture designs discussed below also include features which facilitate installation with few or no extra tools and few steps, allowing easy installation in a wide variety of locations. Such light fixtures can be made very thin relative to conventional light fixtures, and if the use of such light fixtures is contemplated in the design of a building, significant space can be saved through the use of ceilings with less overhead space than would be needed to contain conventional light fixtures. In multistory buildings, the cumulative effect of even a small amount of space savings can be significant as the total number of stories increases.

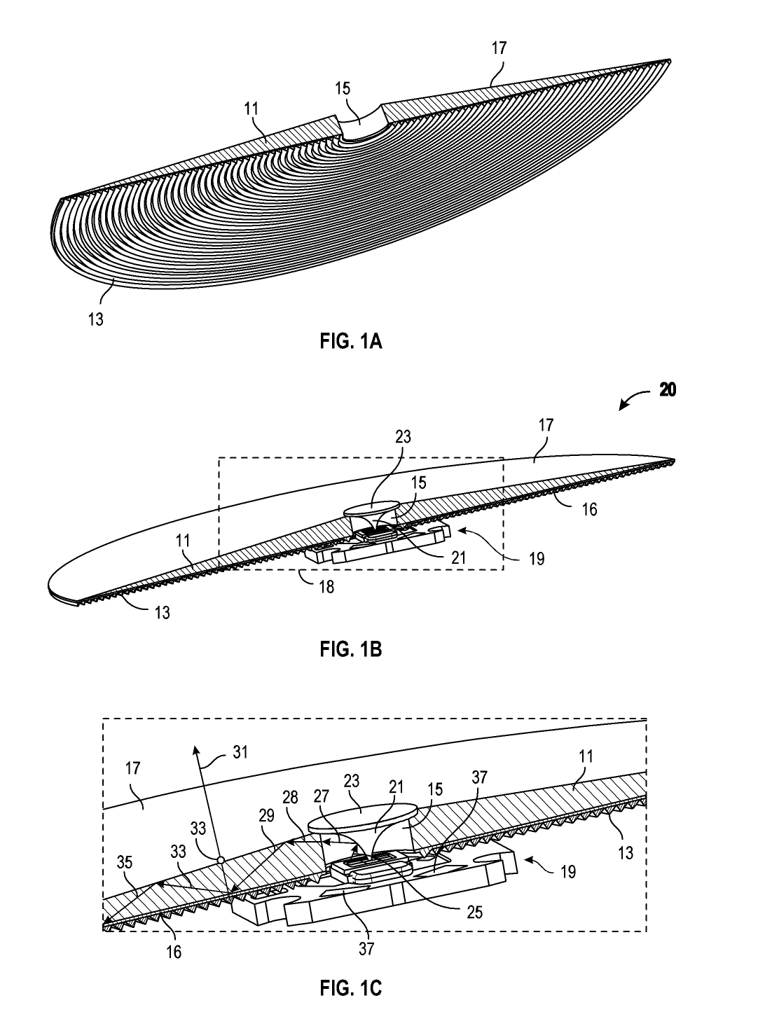

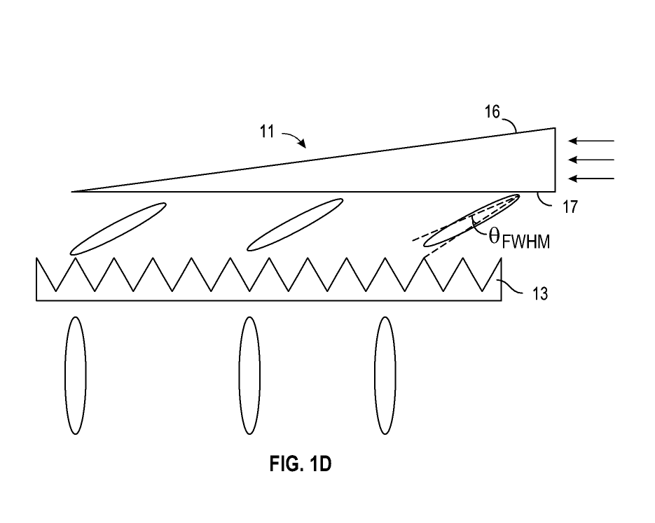

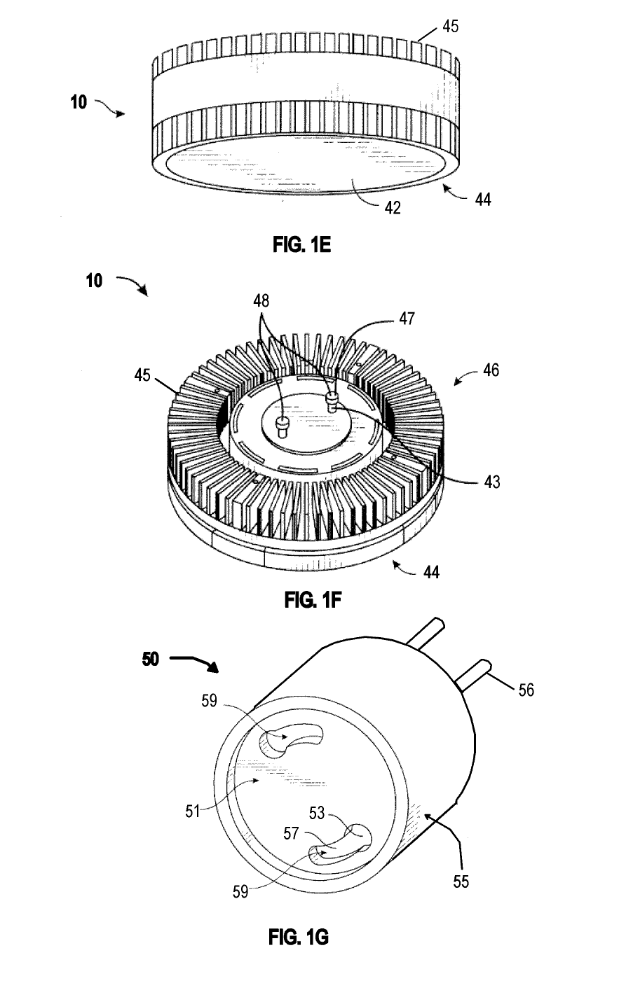

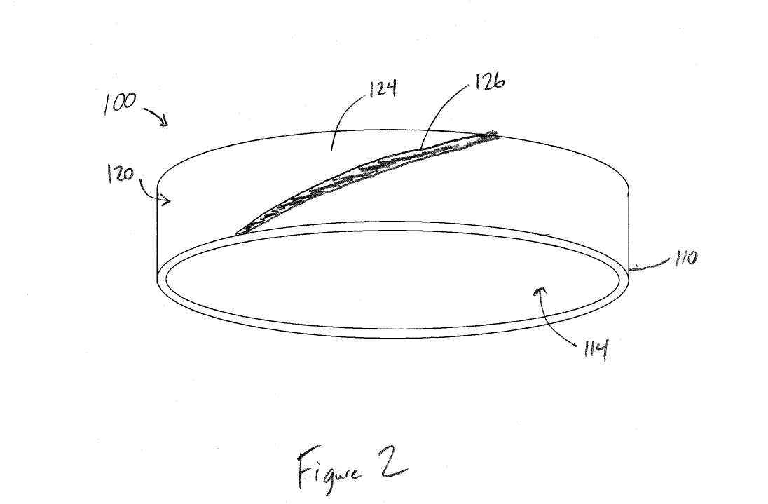

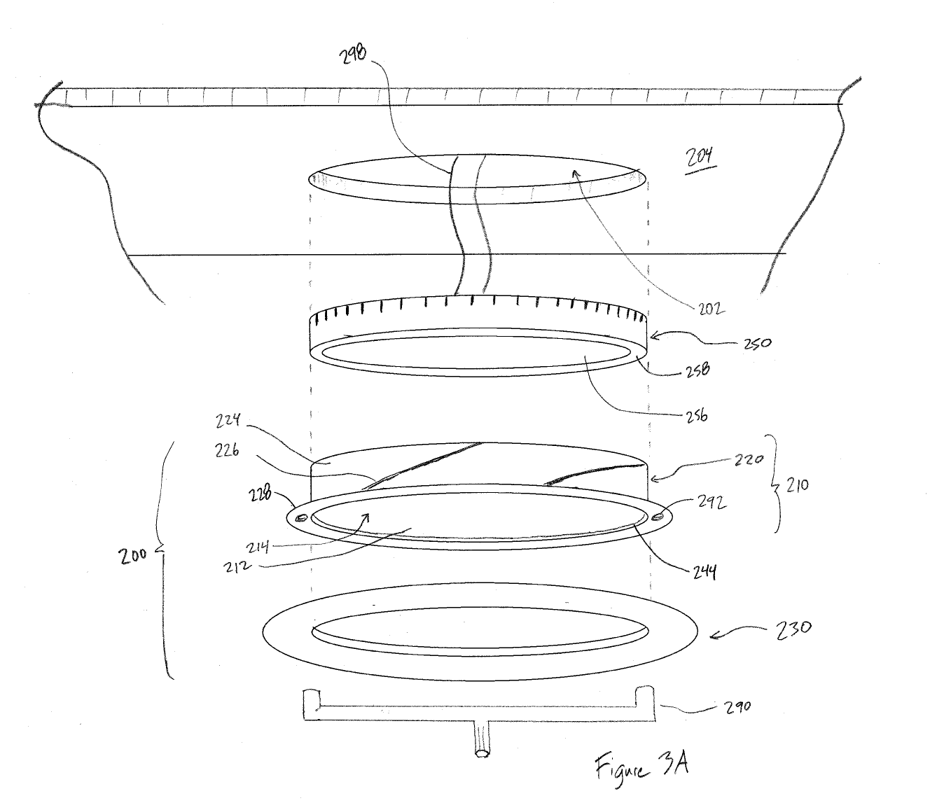

FIG. 1A is a cross-sectional perspective view of an implementation of a circular light guide 100. The circular light guide plate 11 has arranged over its rearward surface a faceted light-turning film 13. The thickness of the light guide plate 11 may decrease from the center towards the perimeter, creating a tapered profile. The light guide plate 11 also includes a central cylindrical surface 15 through which light can be injected into the light guide plate 11. Light entering the central boundary 15 propagates radially through the body of the light guide plate 11 by total internal reflection. In implementations where the light guide plate 11 is tapered, light guided in the light guide plate 11 will propagate by total internal reflection until it is ejected by the tapered light guide plate 11 at an oblique angle relative to the rearward surface 16 and/or the light guide plate 11. The obliquely ejected light can optionally interact with the light-turning film 13. In some implementations, the light ejected by the tapered light guide plate 11 can be a narrow beam having an angular width similar to the taper angle of the tapered pate 11. In some implementations, light-turning film 13 can turn the light so that center of the output beam is substantially normal to the rearward surface 16, the forward surface 17, and/or the light guide plate 11. Alternatively, the light-turning film 13 can be configured to turn the light so that the center of the output beam is at any angle relative to the forward surface 17. In some implementations, the light-turning film 13 can have a metalized surface so as to reflect light emitted from the light guide plate 11 such that the light is turned and output from through light guide plate 11 and emitted from the forward surface 17.

FIGS. 1B and 1C illustrate cross-sectional perspective views of an implementation of an LED emitter combined with the circular light guide plate 11 of FIG. 1A. FIG. 1C shows a magnified view 18 of the cross-section of FIG. 1B. As illustrated, an LED emitter assembly 19 and a radially symmetric reflector 21 are combined with the light guide plate 11 shown in FIG. 1A. Together this structure can comprise a light engine 20. The light emitter assembly 19 may include one or more light emitters such as light emitting diodes. Light emitted from LED emitter assembly 19 reflects off the curved surface 21 of a radially symmetric reflector 23. In some implementations, an etendue-preserving reflector may be used to couple light from the LED emitter assembly 19 to the light guide plate 11. Light entering the light guide plate 11 propagates therein by total internal reflection between rearward surface 16 and forward surface 17, until it is ejected by the tapered light guide plate 11 at an oblique angle relative to the rearward surface 16. For example, light ray 25 shown in FIG. 1C is redirected from the reflector 23 as ray 27 towards the cylindrical surface 15 of the light guide plate 11. On entry, example ray 27 is shown as propagating ray 28, which is reflected off the forward surface 17 of the light guide plate 11 as ray 29 and redirected back towards the rearward surface 16. Light that strikes the surface rearward surface 16 at less than the critical angle passes through rearward surface 16 towards light-turning film 13 and is turned out. Remaining light continues to propagate within the light guide plate 11 by total internal reflection as rays 33 and 35. As illustrated in FIGS. 1A-1C, the light-turning film 13 is arranged under the rearward surface 16 of the light guide plate 11 and is reflective to direct the light out of the forward surface 17.

FIG. 1D illustrates an exploded schematic view of a cross section of another implementation of a circular light guide plate with a light-turning film. As illustrated, the light-turning film 13 is arranged over the forward surface 17 of the light guide plate 11. In this configuration, light enters the light guide 11 from the right side and propagates through the light guide plate 11 as described above. In some implementations, the rearward surface 16 can be metalized so as to prohibit light from being emitted through the rearward surface 16. Light propagates within light guide plate 11 until emitted from forward surface 17 at an oblique angle relative to the forward surface 17. Light emitted from forward surface 17 can interact with light-turning film 13. As illustrated, the light-turning film 13 turns the light such that it exits the light-turning film 13 substantially perpendicular to the light guide plate 11 and the forward surface 17 of the light guide plate 11. The light-turning film 13, in the illustrated implementation, does not substantially affect the angular beam width of the light, for example, the light-turning film 13 does not affect the full width at half maximum of the beam, θ_{FWHM}. Rather, the light-turning film 13 redirects incident light from the circular light guide plate 13. The prism-like features of the light-turning film 13 need not be symmetric, and are shown as symmetric for illustrative purposes only. Although illustrated as turning light to be perpendicular to the forward surface 17, in other implementations the light-turning film 13 can be configured to turn the light at any angle relative to the forward surface 17. Moreover, the light-turning film 13 need not be uniform. For example, one portion may turn light at a first angle, with a second portion turning light at a second angle.

As shown, the light guide plate 11 is tapered such that its thickness decreases radially from the central portion to the peripheral portions. The tapering of the light guide plate 11 further assists light to be turned towards light-turning film 13, and output from the surface 17 of the light guide plate 11. In some implementations, the light guide plate 11 can be sloped from its central portion to its peripheral portions at an angle of about 5 degrees or less. In some implementations, the light guide plate 11 can be sloped at an angle between 1 to 10 degrees. In some implementations, the angle can range from 2 to 7 degrees. The slope of the light guide plate 11 can be related to the width of the light beam exiting the light guide plate 11. In some implementations where narrower beams are preferred, the light beam emitted from the forward surface 17 has a beam width, for example, θ_{FWHM}=60 degrees or less, 45 degrees or less, 30 degrees or less, 15 degrees or less, 10 degrees or less, or 5 degrees or less. In other implementations where wider beams are preferred, the light beam emitted from the forward surface 17 has a beam width, for example, θ_{FWHM}=120 degrees or less or 90 degrees or less. In some implementations where the slope of the light guide plate would be too large to be practical in order to achieve a desired output beam width, the light guide plate 11 may include one or more steps with regions of the light guide plate being sloped as desired rather than the whole light guide plate 11 having one continuous slope as illustrated. In some implementations, the light-turning film 13 or the light guide plate 11 and the light turning film 13 together can be configured to affect angular width of light distribution in addition to only turning the light without affecting the beam width. The configuration of light extraction features can assist in controlling the direction and distribution of light output from the light guide plate 11.

In some implementations, light emitted from LED emitter 19 can be evenly distributed across the surface of the light guide 20. In some implementations, light exiting the light guide 20 is substantially collimated. Additionally, brightness of the source is decreased because the light is distributed across a larger area.

In some implementations, the reflector 23 can be replaced by other functionally similar coupling optics, including segmented reflectors, a lens, groups of lenses, a light pipe section, hologram, etc. As shown, the LED emitter(s) emits light in response to a DC operating voltage applied to terminals 37. In some implementations, the LED emitter assembly 19 may have a different form of light-emitting surface, such as a raised phosphor, raised clear encapsulent, etc.

FIG. 1E shows a perspective view of an example of a light engine incorporating a light guide such as the light guides illustrated in FIGS. 1A-1D. To assist in the description of the implementations described herein, the following coordinate terms are used, consistent with the coordinate axes illustrated in FIG. 1E. A “longitudinal axis” is generally orthogonal to the first side 44 of the light engine 10. A “radial axis” is any axis that is normal to the longitudinal axis. In addition, as used herein, “the longitudinal direction” refers to a direction substantially parallel to the longitudinal axis and “the radial direction” refers to a direction substantially parallel to a radial axis. As illustrated in FIG. 1E, the light engine 10 can have a front side 44 and a back side 46 (see FIG. 1F). The front side 44 can include a light emitting surface or aperture 42 configured to provide light to a space or volume.

As used herein, a light engine refers to any structure that includes at least one light emitter or light emitting element and optical structures associated with the at least one light emitter or light emitting element. For example, a light engine can include a light bulb including a filament light as a light emitter and a diffusive glass bulb surrounding the filament as an optical structure associated with the light emitter. Another example of a light engine can include a light-emitting diode (“LED”) optically coupled to a light guide where the light guide includes means for ejecting light out of the light guide. In thin illumination light engines, the means for ejecting light can include a taper angle between surfaces of the light guide, thereby forming a tapered light guide, as discussed below. In some implementations, the means for ejecting light can include light ejecting facets and/or dot structures. Although illustrated in a particular implementation, the light engine 10 can also include other light engines capable of providing visible light, including, for example, an incandescent bulb, a fluorescent tube, another implementation of a light engine, or any other suitable source of light.

In some implementations, the light engine can include one or more optical conditioners disposed adjacent to the light emitting surface 12 and configured to provide various shapes and types of far-field lighting, for example, a spotlight, a widely spread beam, or a diffuse light, and shaped as circular, square, rectangular, or other shape. In some implementations, the light-turning film 13 of FIG. 1D can be considered an optical conditioner. In some implementations, the optical conditioner is a thin film including a lenticular lens having optical power which is configured to provide various beam shapes. In some implementations, the light engine 10 can include one or more heat transfer structures configured to dissipate heat or thermal energy from the light engine 10. For example, the light engine 10 can include one or more heat transfer fins 45 configured to dissipate heat from a light guide of the light engine 10.

FIG. 1F shows another perspective view of the light engine of FIG. 1A. As illustrated, in some implementations, the back side 46 of the light engine 10 can include one or more electrical connection contacts 48. In some implementations, the contacts 48 can include two or more prongs, blades, or pins, extending longitudinally from the back side 46 of the light engine 10. These contacts 48 may provide electrical and/or mechanical connection between the light engine 10 and a fixture configured to retain the light engine 10.

FIG. 1G shows a perspective view of an example of an adapter configured to be coupled to the light engine of FIG. 1E. The adapter 50 can engage the contacts of a light engine to provide at least electrical connection with the light engine 10 (see FIG. 1E). In some implementations, if the adapter 50 is fixedly coupled to another structure, such as a fixture or a structural member, the adapter 50 can also provide mechanical support to retain the light engine in place. A retention region 51 of the adapter 50 can include two or more terminals 59 configured to receive the contacts 48 of the light engine 10. In this way, the adapter 50 can be at least electrically coupled to the light engine 10 via the engaging structure of the contacts 48 of the light engine 10 and the terminals 29 disposed within the retention surface 51 of the adapter 50.

In one implementation, the adapter 50 is a GU 24 socket and the light engine 10 includes a GU 24 base configured to be retained within the socket, although similar low-profile interconnection structures can also be used. In other implementations which are not as space-constrained, other conventional interconnection structures, such as E26/27, can also be used, and custom or proprietary connectors can also be used. In some implementations, the adapter 50 can include one or more wires or conductive traces (not shown) disposed within the adapter 50 and providing an electrical path between the terminals 59 and wiring 56 extending from the adapter 50 to provide power to the light engine 10. Thus, in some implementations, an adapter 50 may be used primarily to provide electrical connection to the light engine, rather than mechanical support. For example, as discussed in greater detail below, an adapter may be connected to household wiring or an electrical conduit to provide an adapter for easily connecting an installed light engine to a power source.

As shown in FIG. 1F, each contact 48 of the light engine 10 can include a proximal portion 43 extending from the back side 46 of the light engine 10 and a distal portion 47 extending from the proximal portion 43. In some implementations, the distal portion 47 can be enlarged or flared relative to the proximal portion 43 such that the distal portion 47 has a minimum radial dimension that is greater than a maximum radial dimension of the proximal portion 43. As shown in FIG. 1G, each terminal 59 can include a slot having a first portion 53 and a second portion 57. The first portion 53 can be sized and shaped to receive the distal portion 47 of a contact 48. The second portion 57 can be sized and shaped to inhibit the longitudinal movement or withdrawal of a received contact 48 by abutting or otherwise engaging the distal portion 47 of the received contact 48. In this way, the terminals 59 and contacts 48 can engage one another to releasably or temporarily connect the adapter 50 relative to the light engine 10.

As will be discussed in greater detail below, the light engine 10 may in other implementations be supported not from behind via connectors such as contacts 48, but may instead be supported from a radial edge or from the front side 44. Thus, all or a portion of the mechanical support may be provided through contact with portions of the light engine 10 other than the contacts 48, such that electrical connection may be provided separately from mechanical support. The adapter 50 and variants or similar structures discussed herein may thus provide means for electrically connecting a retained light engine to a power source, and in some implementations may also provide means for providing mechanical support to a light engine so as to retain it within a fixture.

FIG. 2 shows an example of a self-anchoring light fixture configured to retain a light engine. The light fixture 100 includes a body portion 110 including a cavity 114 configured to retain a light engine such as light engine 10 of FIGS. 1E and 1F. The body portion 110 includes a cylindrical portion 120 having at least one thread 126 extending around an exterior surface 124 of the cylindrical portion 120.

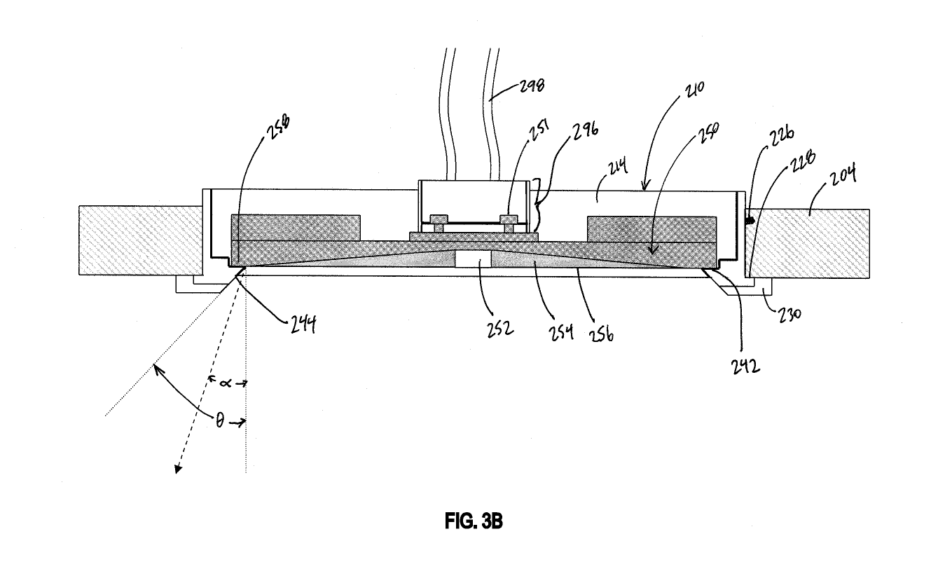

FIG. 3A shows an exploded view of another example of a self-anchoring light fixture configured to retain a light engine. The light fixture 200 includes at least a housing 210 having an aperture 212 on a lower face of the housing, and a cavity 214 within the housing dimensioned to receive a light engine such as the light engine 10 of FIGS. 1A and 1B. In some implementations, the aperture 212 may be open, while in other implementations, the aperture 212 may be removably or fixedly covered with a layer or stack (not shown) of light-transmissive material.

The housing 210 includes a cylindrical portion 220 extending longitudinally upward, on the opposite side of the housing 210 from the aperture 212. An exterior surface 224 of the cylindrical portion 220 includes one or more threads 226 extending radially outward therefrom and extending upward around the exterior surface 224 at an angle to the aperture 212 or another radially extending plane of the housing 210. In one implementation, the threads 226 extend upward at an angle to allow for rotation of the cylindrical portion 220 in a clockwise direction in an aperture to conform to typical threading patterns, but in other implementations, the threads 226 may extend upward at an angle to allow for rotation of the cylindrical portion 220 in a counter-clockwise direction, or may extend straight upwards, without curving around the exterior surface 224, to form longitudinally extending ribs. The amount of rotation required to install the housing 210 is dependent at least in part on the slope of the threads. If the threading is at a steeper angle, less rotation will be required to advance the housing 210 into the aperture 202. Minimizing the amount of rotation may be helpful when the housing is installed after connecting external wiring 298 to a retained light engine 250, as a reduction in the amount of rotation will minimize twisting in the wiring.

The height of the cylindrical portion 220 of the housing 210 may depend on the location in which the light fixture 210 is configured to be installed. In the implementation illustrated in FIG. 3A, the fixture 200 is configured to be installed within an aperture 202 formed in a ceiling tile 204, although in other implementations, the fixture may be configured to be installed in any suitable structural members, including ceilings, soffits, walls or any other structural member. These structural members may be formed from soft or otherwise machinable building materials, including but not limited to gypsum board, drywall, plaster, wood, plastic, metal, composites or engineered materials such as particle boards or medium-density fiberboard (MDF), or any other suitable building materials. For convenience, implementations below may be described with respect to a ceiling tile such as ceiling tile 204, but are applicable for use with any suitable structural member. In some implementations, these structural members may be disposed adjacent a hollow space, such that a portion of the structural member may be cut out or otherwise removed to form an aperture allowing access to the hollow space on the opposite side of the structural member.

In some implementations, the height of the cylindrical portion 220 is equal to or greater than the thickness of the ceiling tile or other structural member in which the fixture 200 is to be installed. For example, ceiling tiles are available in a variety of standard thicknesses, including but not limited to ½″, ⅝″, 1″, and 2″. In some implementations, the height of the cylindrical portion 220 is thus greater than ½″, ⅝″, greater than 1″, or greater than 2″. Similarly, other structural members such as those mentioned above may be provided in discrete thicknesses, and light fixtures may be designed for use with any of those discrete thicknesses.

In an implementation in which the height of the cylindrical portion 220 is greater than a height of the ceiling tile 204 in which it is to be installed, the thread or threads 226 may not extend along the entire height of the cylindrical portion 220, but may instead extend only along a portion of the height of the cylindrical portion 220. In a particular implementation, the thread 226 may extend along a portion of the cylindrical portion 220 having a height greater than the thickness of the ceiling tile 204.

Installation of the fixture may include alignment of the cylindrical portion 220 with the aperture 202 in the ceiling tile 204, followed by rotation of the housing 210 to screw the cylindrical portion into the aperture 202, as will be discussed in greater detail below. The diameter of the cylindrical portion 220 is roughly the same, or slightly less, than the diameter of the aperture 202 in the ceiling tile 204. The diameter of the outer edge of the threads 226 is greater than the diameter of the aperture 202, such that the threads 226 extend into or cut into the ceiling tile 204 surrounding the aperture 202 to secure the housing 210 in place. The threads 226 and variants or similar structures discussed herein may thus provide means for retaining the light fixture relative to a structural member such as a ceiling or wall. In some implementations, a pre-cut aperture 202 also includes pre-cut grooves extending radially around the interior face of the aperture 202 which the thread or threads 226 can engage, reducing the amount of force used to screw the housing 210 into the aperture 202. In some implementations, the housing 210 includes a lip 228 extending radially outward at the base of the cylindrical portion 220 to serve as a stop and prevent advancement of the cylindrical portion 220 beyond the lower surface of the ceiling tile 204.

In some implementations, rotation of the housing 210 may be facilitated by providing recesses 292 in the housing 220. In the illustrated implementation, the recesses 292 are formed in a lower surface of the housing 220, although the recesses 292 may be positioned anywhere where they can be engaged to rotate the housing 220. In one implementation, a drive tool 290 configured to engage one or more of the recesses 292 may be used to rotate the housing 210. For example, as illustrated, the illustrated drive tool 290 may simultaneously engage two recesses 292 on opposite sides of the housing 210, and may be rotated either by hand or using a drill or other machine or power tool to screw the housing 210 into the aperture 202. In some implementations, the recesses 292 can be filled or covered after use during installation, such as via press-fit plugs (not shown).

The light fixture 200 may also include an additional bezel 230 which may be removably secured to the housing 210 and extend radially outward underneath a portion of the ceiling tile 204 adjacent the aperture 202. The bezel 230 may be primarily aesthetic, or may provide structural support to the light engine or to other components of the light fixture 200, as discussed in greater detail below. In some implementations, the bezel 230 may include threading on an interior face of the bezel to allow the bezel to be screwed onto a downwardly extending portion of the housing 210. In other implementations, the bezel 230 may be snap-fit or press-fit to the housing 210, may be secured to the housing via fasteners, or may be removably secured to the housing 210 by any other suitable method.

FIG. 3B shows a cross-section of the assembled light fixture of FIG. 3A after installation. The light fixture 200 (see FIG. 3A) is retaining a light engine 250 within the cavity 214 of the light fixture 200. The light engine 250 is schematically depicted as including a light source 252 such as an LED and a tapered light guide 254 configured to reflect light downward through an output surface 256 of the light guide 254. The tapered light guide 254 can be configured to direct light over a constrained range of angles, such that all or most of the light is generally collimated and directed at an angle to the normal that is less than the illustrated angle α. While the beam width is illustrated in FIG. 3B as being within an angle α of normal, it is understood that the beam may be configured using optical films in the path of light exiting the output surface 256 of the light engine 250 so that the beam has a width of angle α about an arbitrary, non-normal vector extending from the output surface 256.

It can be seen in FIG. 3B that the housing 210 includes a lip 240 extending radially inward and providing support for the light engine 250. Thus, the lip 240 and variants or similar structures discussed herein may provide means for providing mechanical support to a light engine so as to retain it within a fixture. The cavity 214 and the lip 240 are dimensioned such that the cavity 214 has a cross-sectional dimension which is greater than or substantially equal to the outer cross-sectional dimension of the light engine 250, while a minimum cross-sectional dimension between the interior edge of the lip 240 is less than the outer cross-sectional dimension of the light engine 250. In some implementations, the minimum cross-sectional dimension between the interior edges of the lip 240 is greater than a maximum cross-sectional dimension of the output surface 256 of the light guide 254, such that the lip 240 is only in contact with the border portion 258 of the light engine 250 surrounding the output surface 256 of the light guide 254. When the components of the light fixture 200 are dimensioned in this way, the light engine 250 can be positioned such that the output of the light engine 250 is not blocked by the fixture components. This positioning can be maintained by a slight depression 242 in the upper surface of the lip to seat the light engine 250 therein, or by a tight fit between the light engine 250 and the walls of the cavity 214.

Similarly, the interior face 244 of the lip 240 may be radially tapered outward in a downward direction to further avoid blocking of the light. In particular, if the light is constrained to exit the light guide at angles to the normal less than the illustrated angle α, tapering the interior face 244 at an angle θ which is greater than the light exit angle α will minimize or avoid interference with the output light by the lip 240. As discussed above, in some implementations the light engine may generally constrain light output to within 15° of the normal. Thus, in some implementations, the interior face 244 of the lip 240 may be tapered outward at least 15°, at least 30°, or at least 45°, although tapers that are greater than 45° or less than 15°, or anywhere between the two, may also be used.

In some implementations, the lip 240 may extend all the way around the interior edge of the cavity 214. However, in other implementations, the lip 240 may be two or more separated or partially separated structures. For example, the lip 240 may include two arc-shaped sections opposite one another, each of which circumscribe only a portion of facing semicircles. In other implementations, the lip 240 may include more than two separate sections, for example, three or four sections. If the spacing between the sections of the lip 240 is sufficiently wide, the gaps therebetween may allow the light engine 250 to be turned in a vertical direction and inserted into or removed from the cavity 214 even after installation of the housing 210 within the aperture 202. When the light engine is oriented horizontally, however, the sections of the lip 240 can support the light engine 250 from below and prevent the light engine from moving or falling out of the cavity 214.

In other implementations, support for the light engine 250 may be provided not by a lip 240 extending inwardly from the housing 210, but instead from an inwardly extending portion of a removable bezel 230. In such an implementation, the light engine 250 may be freely inserted into and removed from the cavity 214 when the bezel 230 is not in place. In such an implementation, the bezel 230 and variants or similar structures discussed herein may also provide means for providing mechanical support to a light engine so as to retain it within a fixture. In some implementations, the interior edge of the bezel 230 may be tapered in a similar fashion to that discussed above with respect to the interior face 244 of lip 240.

Implementations such as those discussed above, in which the light engine 250 is readily removable from an installed housing 210, facilitate the easy replacement or removal of light engines 250. In implementations in which removal of the light engine 250 is more difficult, the light engine 250 may be disposed within the cavity 214 of the housing 210 prior to installation of the housing 210 within the aperture 202 in ceiling tile 204.

The light engine 250 may be placed in electrical communication with external wiring 298 using an adapter 296, which is configured to provide at least electrical connection for the light engine 250. The adapter 296 may be similar in structure to the adapter 50 of FIG. 1G, and can engage contacts 251 disposed on the opposite side of the light engine 250 from the light guide 254 to place the contacts 251 in electrical communication with the external wiring 298 via conductive pathways (not shown) within the adapter, such as wiring or conductive traces. The adapter 296 may be connected to the open wiring 298 in the space above a false ceiling at the time the aperture 202 is formed in the ceiling tile 204, to facilitate later installation of the light fixture 200 in the aperture 202. For example, the adapter 296 may include wiring (such as wiring 56 of FIG. 1G) extending from the adapter 296, which can be secured to the open wiring via wire clamps or any other suitable method. Depending in part on the structure of the housing 210, the adapter 296 may be secured to the light engine 250 either before or after installation of the housing 210 within the aperture 202. In other implementations, as discussed in greater detail below, the adapter may be placed in at least electrical connection with wiring extending within an electrical conduit in the space overlying the ceiling tile 204. Thus, the adapter 296 and variants or similar structures discussed herein may provide means for electrically connecting a retained light engine to a power source.

As illustrated in FIG. 3B, the installed light fixture is supported only by the surrounding ceiling tile, and does not require additional securement to a frame or other more rigid member of a building's structure. In some implementations, the total weight of a light fixture and an installed light engine such as an LED-based light engine may be as low as or less than one pound. In contrast, conventional “can”-type lighting fixtures designed to receive an incandescent bulb may weigh at least five pounds and may weigh up to or more than 20 pounds. Troffers configured to retain banks of fluorescent lights may weigh at least 50 pounds. The significant reduction in weight enabled by the use of compact light engines enables installation of fixtures in a greater variety of locations, and the installation is substantially simpler than installation of fixtures which require supplemental securement.

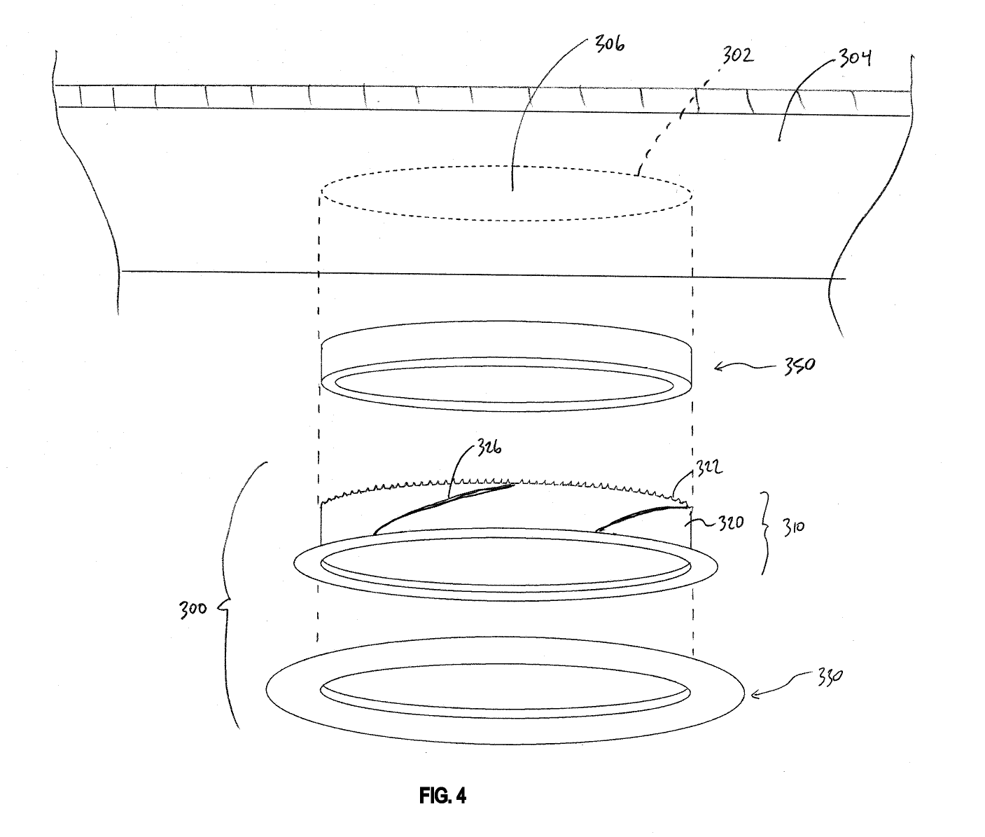

FIG. 4 shows an example of a self-anchoring light fixture which does not require a pre-cut aperture. The light fixture 300 is similar to the light fixture 200 of FIGS. 3A and 3B, except that the upper edge 322 of the cylindrical portion 320 is serrated, sharpened, or otherwise configured to cut into the ceiling tile 304 to form an aperture 302 (shown in outline in FIG. 4) when the upper edge 322 of the cylindrical portion 320 is positioned against the ceiling tile 304 and the housing 310 is rotated.

Installation of the light fixture 300 can proceed in a similar fashion to that discussed above with respect to light fixture 200, except that rather than aligning the housing 310 with an aperture, the housing 310 is positioned where the aperture is desired. As the housing 310 is rotated to cut into the ceiling tile 304, the threading 326 on the exterior surface 324 of cylindrical portion 320 will cut into the surrounding ceiling tile 304 to secure the housing 310 in place.

In implementations in which the height of the cylindrical portion 320 is greater than the height of the ceiling tile 304, the portion of the ceiling tile 304 within the edges of the aperture to be formed will be completely separated from the surrounding ceiling tile 304, and can be subsequently removed to facilitate passage of wiring and/or the light engine 350 into the newly formed aperture. If the light engine 350 is to be supported by inwardly extending tabs forming a lip such as lip 240 of FIGS. 3A and 3B, or by an underlying removable bezel 330 as discussed above, the interior portion 306 of the ceiling tile 304 may simply be removed through the aperture 312 at the base of housing 310.

As discussed above with respect to fixture 200, rotation of the housing may be facilitated through the use of a drive tool (such as drive tool 290 of FIG. 3A) configured to engage one or more recesses (such as recesses 292 of FIG. 3A) formed in the housing 310. The drive tool may be driven either by hand or mechanically, such as through the use of a power tool connected to the drive tool.

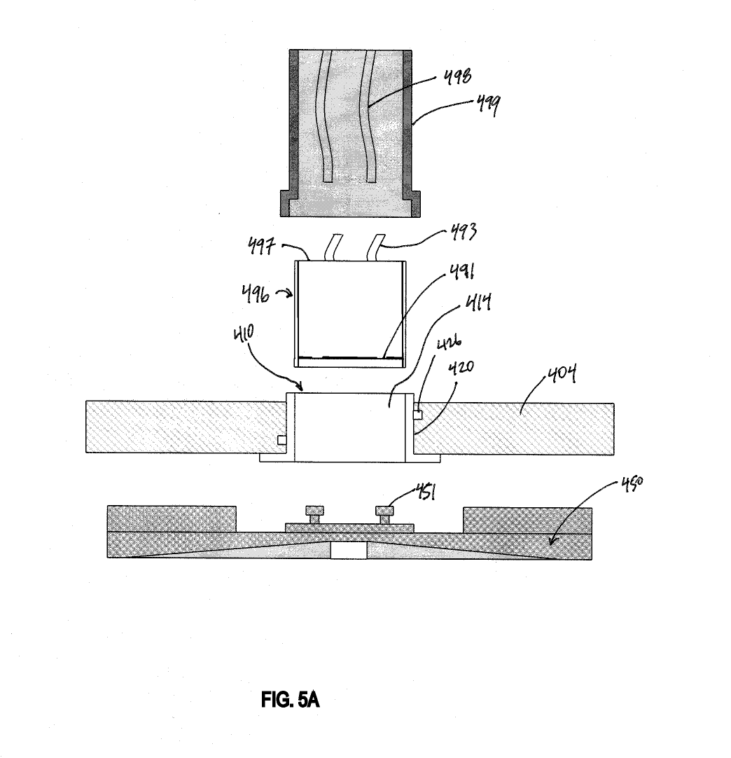

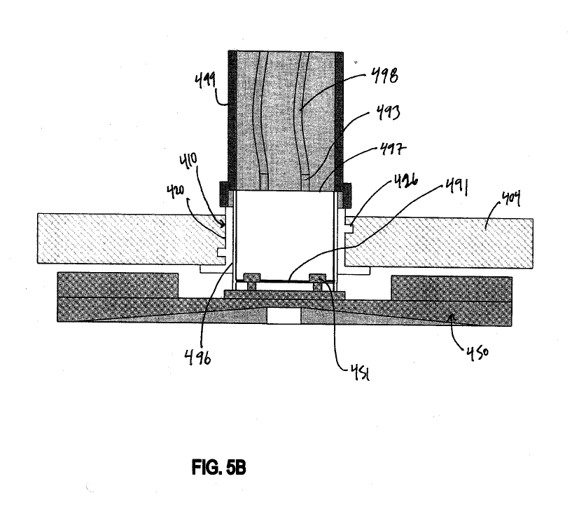

FIG. 5A shows an example of an exploded cross-section of a fixture configured to be installed within an aperture having a cross-sectional dimension less than the cross-sectional dimension of a retained light engine. The fixture 400 of FIG. 5 includes a body 410 having a threaded cylindrical portion 420 with threads 426, which is configured to be installed within an aperture in ceiling tile 404 as shown. The cylindrical portion 420 includes a cavity 414 extending therethrough. An adapter 496 configured to extend through at least a portion of the cavity 414 includes a retention portion 491 configured to engage contacts 451 on the light engine 450, and wiring 493 extending from the adapter 496. This retention portion 491 may be similar in structure to the retention surface 51 of the adapter 50 of FIG. 1G, including one or more terminals configured to receive contacts 451 extending longitudinally upward from the light engine 450. The upper portion 497 of the adapter is dimensioned to engage with the lower end of an overlying electrical conduit 499 which encloses external wiring 498. In some implementations, the upper portion 497 of the adapter 496 may include a length of conduit, although a wide variety of adapter designs may also be used.

In an implementation in which the adapter 496 is configured to be retained within the cavity 414, such as by frictionally engaging the cavity 414, the adapter 496 may also provide mechanical support to the light engine 450 via the connectors 451 or via another structure. In other implementations, one or both of the body 410 or the adapter 496 may be configured to interact directly with the light engine 450 to support the light engine 450.

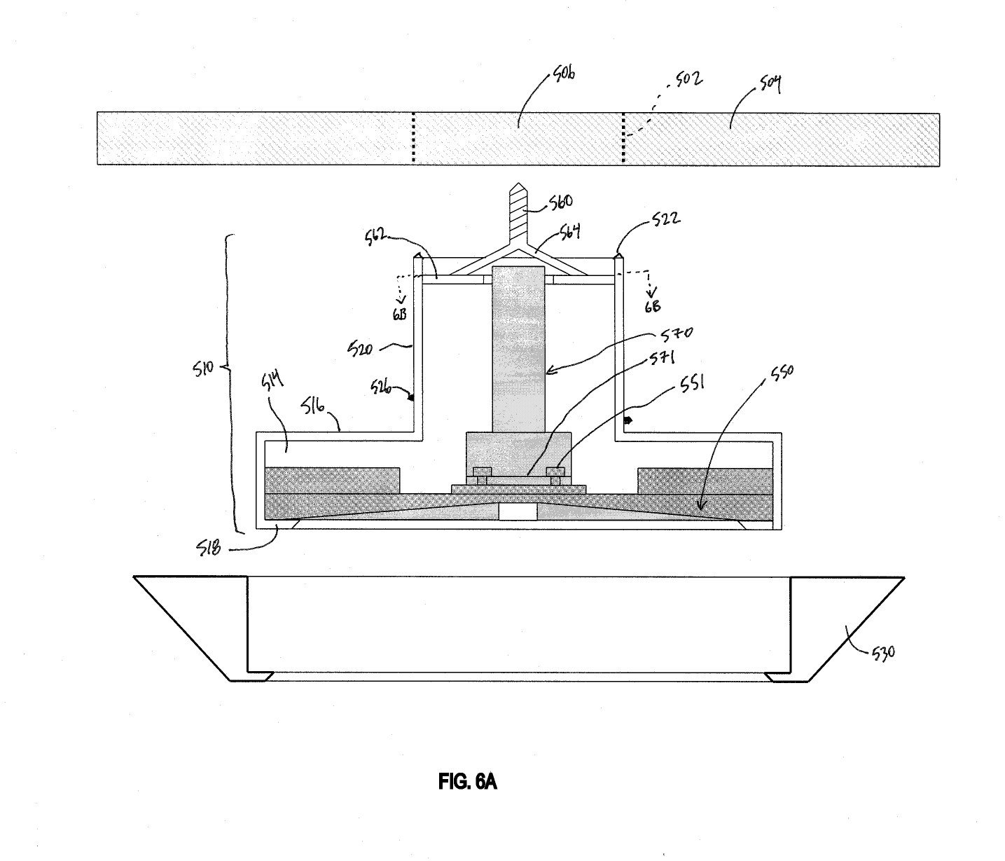

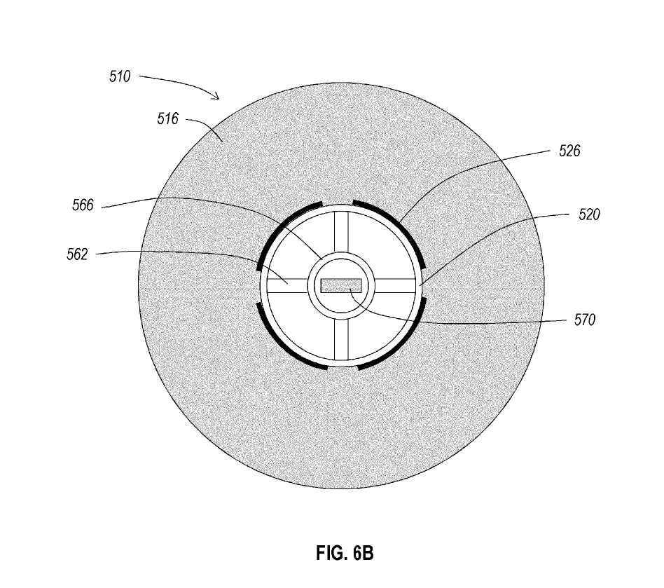

For example, the body 410 may include support components, at least a portion of are located radially outward of the sides of the light engine 450 to engage either the side edge or the underside of the light engine 450 to retain the light engine 450. One such example of a body which can be retained within an aperture smaller than a retained light engine and retain the light engine is illustrated in FIG. 6A and 6B below, for example. In other implementations, one or both of the body 410 and adapter 496 may be configured to interact with another fixture component (not shown) such as a removable bezel to support the light engine 450 therebetween. A bezel may also be included in any of the above implementations for aesthetic purposes in addition to providing primary or supplemental structural support.

As discussed herein with respect to other implementations, the body 410 may be configured to be installed within a precut aperture in the ceiling tile 404, or may include a serrated upper edge or other structure configured to cut into the ceiling tile to form an aperture during installation.

FIG. 5B shows an example of a cross-section of the assembled fixture of FIG. 5A. In FIG. 5B, it can be seen that the adapter 496 has been retained within the cavity 414 (see FIG. 5A) of the body 410. The light engine 450 has been secured to the adapter 496 by engaging the connection portion 491 of the adapter 496 with the contacts 451 of the light engine 450. The upper portion 497 of the adapter 496 has been secured to the terminal end of the conduit 499, and the adapter wiring 493 has been connected to the external wiring 498 within the conduit 499. The securement between the adapter 496 and the conduit 499 may be achieved via any suitable connection, such as by press-fit, snap-fit, threaded screws, fasteners, adhesives, or otherwise treating or manipulating the materials of one or both of the adapter 496 and the conduit 499. The adapter 496 and conduit 499 may be directly joined to one another, or may in other applications more typically be joined together using an intermediary union to which both the adapter 496 and conduit 499 are secured, through the use of set screws or any other suitable retaining structures.

Although in the illustrated implementation the adapter 496 is retained within the body 410 and provides structural support for the light engine 450, other implementations may provide support for the light engine 450 in other ways. In an implementation in which the adapter does not need to provide mechanical support for the light engine, the adapter may extend freely through the body 410 without being retained therein, and may be connected to an overlying conduit. As discussed above, the adapter may be attached to the conduit at any suitable time during the installation process. For example, the adapter may be attached to the conduit before or after the aperture is formed, such as immediately after forming the aperture. The illustrated implementation of the adapter 496 thus provides means for electrically connecting a retained light engine to a power source, and may optionally also provide means for providing mechanical support to a light engine so as to retain it within a fixture.

FIG. 6A shows an example of a self-anchoring light fixture which includes additional features configured to facilitate installation of the light fixture. The light fixture 500 includes a housing 510 which includes a lower cavity 514 configured to retain a light engine 550, and an upwardly extending cylindrical portion 520 having a serrated upper edge 522 or other similar structure configured to cut into a ceiling tile 504 to remove a portion 506 so as to form an aperture 502 (shown in outline in FIG. 6A). In the illustrated implementation, the cross-sectional dimension of the cylindrical portion 520 is less than the cross-sectional dimension of the portion of the housing 510 defining the cavity 514, such that the surface 516 defining the upper portion of cavity 516 will sit flush against the ceiling tile 504 when installed, rather than being inserted into the aperture 504 formed by the cylindrical portion 520.

In addition to the cutting surface provided at the upper edge 522 of the cylindrical portion 520, the fixture 500 includes a pilot drill 560 extending longitudinally upward beyond the upper edge 522 of the cylindrical portion 520. When the housing 510 is rotated, the pilot drill 560 will pierce the ceiling tile 502 and stabilize the housing 510 during rotation of the housing 510, allowing an installer to precisely position the installed light fixture. In some implementations, the pilot drill 560 is supported by one or more arms 562 and/or 564 extending at least radially inward. In the illustrated implementation, arms 562 extend radially inward from the inner wall of cylindrical portion 520, and support tower arms 564 which extend radially inward and longitudinally upward to support the pilot drill 560.

In a further implementation, at least the pilot drill 560 and in some further implementations at least a portion of the arms 562 or 564 supporting the pilot drill 560 are detachable from the remainder of the housing 510 once the housing 510 is installed within an aperture formed within the ceiling tile 504. In a particular implementation, removal of the pilot drill 560, along with a portion or all of the radially extending arms 562 and 564) may assist with removal of the cutout portion of the wall 560 within the cylindrical portion 520, as both the pilot drill 560 and the cutout portion can be removed together. In still other implementations, the pilot drill may be detached 560 partway through installation of the housing 510, such as by allowing the housing 510 to begin to cut into the ceiling tile 504, retracting and detaching the pilot drill 560, and continuing to install the housing 510 using the partially cut aperture 502. In other implementations, the pilot drill 560 is not removed, and instead remains in place as part of the installed light fixture 500.

In an implementation such as the one depicted in FIG. 6A, in which the housing 510 includes a portion extending longitudinally upward beyond the upper surface of light engine 550, an adapter 570 or extension portion may include a connection portion 571 configured to interact with contacts 551 of light engine 550 so as to facilitate electrical connection with external wiring as discussed above with respect to other implementations. Particularly when the cylindrical portion 520 is narrow, providing an adapter 570 which extends towards the upper edge 522 of cylindrical portion 520 facilitates connection of the light engine 550 with external wiring (not shown) powering the light engine.

In the illustrated implementation, the body 510 includes tabs 518 or other suitable retaining structures extending into the cavity 514 and configured to retain the light engine 550 therein. In alternate implementations, however, the light engine 550 can be retained between the body 510 and the bezel 530, or retained within the bezel 530. Similarly, in the illustrated implementation, the bezel 530 includes recesses 592 configured to receive a driving tool, such that the assembled light fixture 500 will be driven into the ceiling tile 504 after assembly of the body 510 and the bezel 530 together. However, in alternate implementations, the recesses 592 may be provided in the body 510, such that the body 510 may be screwed into the ceiling tile 504 and the bezel 530 and/or light engine 550 later secured relative to the installed body 510.

FIG. 6B shows a cross-sectional view of the body portion of the light fixture of FIG. 6A, taken along line 6B-6B. As can be seen in FIGS. 6A and 6B, in the illustrated implementation the pilot drill 560 is supported by a structure including arms 562 extending radially inwardly from the walls of the cylindrical portion 520 as well as tower arms 564 which extend both radially inwardly and longitudinally upward from the structure including arms 562. As can additionally be seen in FIG. 6B, the structure including arms 562 additionally includes a central portion 566 circumscribing the center of the cylindrical portion 520 and allowing the adapter 570 to extend upward through the plane of the structure formed by arms 562 and central portion 566. Since the tower arms 564 extend longitudinally upward from the structure formed by arms 562 and central portion 566, the adapter 570 can extend flush or nearly flush with the upper edge 522 of cylindrical portion 520 without interfering with pilot drill 560 or the structures supporting the pilot drill 560. In alternate implementations, a structure supporting pilot drill 560 may not include a generally planar portion, but may only include arms such as tower arms 564 extending both radially inward and longitudinally upward from attachment points on the interior surface of the cylindrical portion 520.

Although described with respect to specific illustrated implementations, a wide variety of self-anchoring light fixtures may be provided utilizing any appropriate configuration of aspects of the implementations described above. For example, the implementations described above may be used either in conjunction with a serrated edge or edge otherwise configured to cut into a structural member to form an aperture, or may be used in conjunction with a pre-formed aperture to secure a light fixture therein. Similarly, light engines may be directly supported by a body or similar portion of a light fixture configured to be retained within an aperture formed in a structural member, but may also be supported by a removable component such as a bezel attached to a fixture component secured within an aperture, or may be supported between two fixture components without being directly secured to either component.

Light fixtures such as those discussed herein may be formed from a wide variety of materials. In an implementation in which the housing includes a cylindrical portion configured to cut into a ceiling tile or other structural member, the housing may include metal, hard plastic, or any other suitable material sufficiently hard to cut through the structural member in which the light fixture is to be installed. The hardness of the material may vary based on the structural material in which the aperture is to be formed. For example, plastics may be sufficient to cut through materials such as gypsum board (sheet rock), wood, or other materials such as composite materials.

In other implementations in which the fixture is configured to be installed within a pre-cut aperture, an even wider variety of materials may be suitable, including relatively softer plastics. In such an implementation, a separate cutting tool made of harder material such as metal may be provided along with the fixture, to facilitate the installation of multiple similar fixtures. The cutting tool may be similar in size and shape to the cylindrical portion of the fixture, and may also include threading on the outer surface of the tool to form grooves dimensioned to receive threading on the fixture during installation. The cutting tool may either be configured to engage directly with a tool such as a power drill, such as by including a bit configured to be retained within a power drill, or may be configured to engage with a separate drive tool such as drive tool 292 of FIG. 2A.

In a particular implementation, a separate cutting tool may be at least twice as thick as the structural material in which the aperture is to be formed, and may include an upper unthreaded portion adjacent the cutting edge and at least as thick as the structural material, and a lower threaded portion. Such an implementation allows the upper portion to form the aperture, while the lower portion can form grooves in the interior face of the aperture after the aperture has been cut out. A separate cutting tool can also include a pilot drill such as the pilot drill 560 of FIG. 6A, in order to direct the cutting surface of the cutting tool.

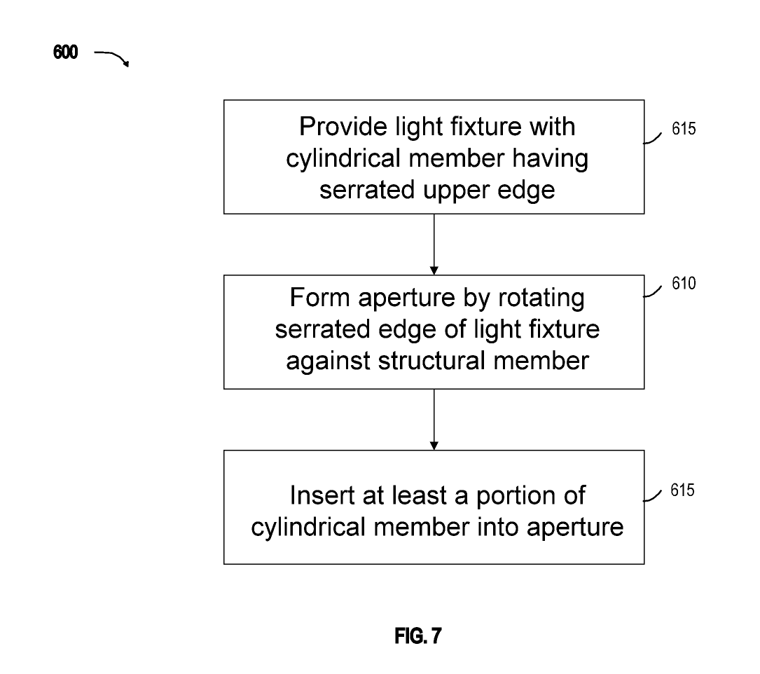

FIG. 7 is a block diagram showing an example of a method of installing a self-anchoring light fixture. The method 600 begins at a step 605 where a housing having a cylindrical portion with a serrated upper edge is provided. In alternate implementations, the upper edge of the cylindrical portion may be sharpened or otherwise configured to cut into a structural member such as a ceiling tile.

The method then moves to a step 610, where an aperture is formed in a structural member such as a ceiling tile by placing the serrated upper edge of the housing adjacent the structural member and rotating the housing. In some implementations, the housing is configured to retain a light engine and the aperture formed by the rotation of the housing has a cross-sectional dimension which is larger than a cross-sectional dimension of a light engine. In other implementations, the cross-sectional dimension of the aperture is smaller than the cross-sectional dimension of the light engine.

The method then moves to a step 615, where at least a portion of the cylindrical member is inserted into the aperture. In certain implementations, the same rotation of the housing can perform both the steps of forming an aperture in the structural member and inserting at least a portion of the cylindrical member into the aperture.

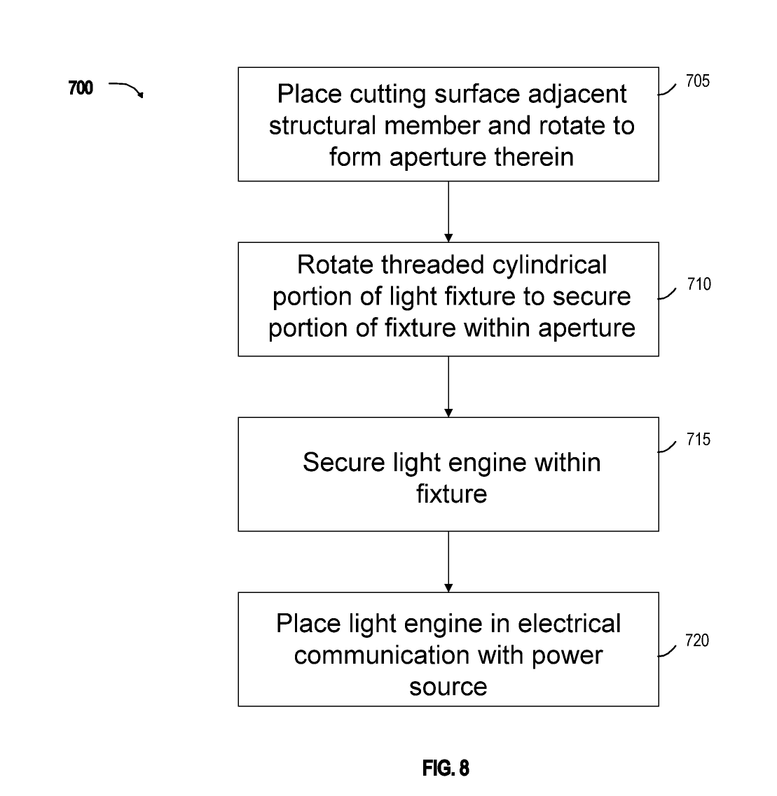

FIG. 8 is a block diagram showing an example of another method of installing a self-anchoring light fixture. The method 700 begins at a step 705 where a cutting surface is placed adjacent a structural member and rotated to form an aperture in the structural member, such as a ceiling tile. In some implementations, the cutting surface may be provided on the upper edge of a portion of the self-anchoring light fixture to be installed. In other implementations, the cutting surface may be provided on a separate cutting tool as discussed above.

The method then moves to a step 710, where a threaded cylindrical portion of the light fixture is rotated to screw the cylindrical portion into the aperture in the structural member. In an implementation in which the cutting surface is the upper edge of a portion of the light fixture, steps 705 and 710 may be performed at least partially simultaneously, as the rotational motion of the portion of the fixture relative to the structural member can both form the aperture and screw the fixture portion into the aperture. Both of steps 705 and 710 can be performed by hand, or with the assistance of a tool such as a power tool, as discussed above.

The method then moves to a step 715, where a light engine is secured within the fixture. In some implementation, this step 715 may include the assembly of portions of the fixture, such as the securement of a bezel to a body portion of a fixture to retain a light engine therebetween. The method then moves to a step 720, where the light engine is placed in electrical communication with a power source. In some implementations, this may be done by connecting external wiring to an adapter, and connecting the adapter to the light engine.

As discussed above, the order of the above steps may vary significantly depending on the installation method and the design of the light engine. For example, in an implementation in which the light engine is retained by a lip extending around the base of the cavity, such that the light engine is most easily inserted from above, one or both of step 715 of securing the light engine within the fixture and step 720 of placing the light engine in communication with a power source may be performed before step 710 of rotating the fixture to secure the fixture into place. Other variations to the order of the above steps may also be used.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the light fixture or light engine as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations. Additionally, other implementations are within the scope of the following claims. In some cases, the actions recited in the claims can be performed in a different order and still achieve desirable results.

What is claimed is:

1. A self-anchoring light fixture, comprising:
a body portion configured to retain a light engine;
a bezel removably coupled to a first side of the body portion, wherein the bezel permits light from the light engine to exit the light fixture through a central portion of the bezel; and
a hollow cylindrical member extending from a second side of the body portion opposite the first side and having a cross-sectional diameter, wherein the cylindrical member includes a serrated upper edge.

2. The fixture of claim 1, wherein the body portion has a first cross-sectional dimension, and wherein the hollow cylindrical member has a cross-sectional diameter, wherein the cross-sectional diameter of the cylindrical member is less than the first cross-sectional dimension of the body portion.

3. The fixture of claim 1, wherein the cylindrical member includes a pilot drill extending upwards beyond the serrated upward edge of the cylindrical member and a support assembly supporting the pilot drill.

4. The fixture of claim 3, wherein the support assembly includes a plurality of arms extending inwardly from the interior walls of the cylindrical member.

5. The fixture of claim 3, wherein at least the support assembly and the pilot drill are detachable from the light fixture.

6. The fixture of claim 1, wherein the cylindrical member includes a wiring adapter extending upward from the body portion along at least a portion of the height of the cylindrical member, wherein the wiring adaptor is configured to provide a conductive path between the light engine and an external power source.

7. The fixture of claim 6, wherein the wiring adaptor is supported by a plurality of arms extending inwardly from the interior walls of the cylindrical member.

8. The fixture of claim 1, wherein the cylindrical member includes a thread extending around an outer surface of the cylindrical member.

9. A light fixture, comprising a body portion configured to receive a light engine and including a hollow cylindrical portion with at least one thread extending around a surface of the hollow cylindrical portion.

10. The fixture of claim 9, additionally including a bezel extending around the perimeter of the body portion.

11. The fixture of claim 10, wherein the hollow cylindrical portion has a first diameter, and wherein the bezel has a second diameter, the second diameter being larger than the first diameter.

12. The fixture of claim 9, wherein an upper edge of the hollow cylindrical portion is configured to cut into a wall or ceiling material during installation of the fixture.

13. The fixture of claim 12, wherein the body portion includes one or more receptacles adapted to receive portions of a drive tool to allow the light fixture to be rotated during installation of the fixture.

14. A method of installing a light fixture, comprising:
providing a light fixture, the light fixture including:
a body portion configured to retain a light engine on a first side of the body portion, wherein the body portion has a first cross-sectional dimension; and
a hollow cylindrical member extending from a second side of the body portion opposite the first side, and having a diameter, and wherein the cylindrical member includes a serrated upper edge;
forming an aperture in a wall or ceiling by rotating the light fixture such that the serrated edge of the cylindrical member cuts through the wall or ceiling to form an aperture; and
inserting at least a portion of the cylindrical member into the aperture.

15. The method of claim 14, wherein the light fixture additionally includes a pilot drill extending upwards beyond the serrated upward edge of the cylindrical member and a support assembly supporting the pilot drill, wherein the pilot drill is configured to retain the light fixture in place during the rotation of the light fixture to form the aperture in the ceiling or wall.

16. The method of claim 15, additionally including removing the pilot drill and support assembly after the aperture is formed in the ceiling or wall.

17. The method of claim 14, additionally including securing a bezel to the first side of the body portion, wherein the bezel permits light from the light engine to exit the light fixture through a central portion of the bezel.

18. The method of claim 14, additionally including securing a light engine within the body portion of the fixture.

19. The method of claim 18, additionally including connecting the light engine to a power source via wiring extending through the cylindrical member.

20. A method of installing a light fixture, comprising:
providing a light fixture having a body portion configured to receive a light engine and a hollow cylindrical portion with at least one thread extending around a surface of the hollow cylindrical portion; and
rotating the light fixture such that the thread engages the interior of an aperture formed in a wall or ceiling and at least a portion of the hollow cylindrical portion is inserted into the aperture.

21. The method of claim 20, wherein the upper edge of the hollow cylindrical portion is configured to cut into a wall or ceiling during installation of the fixture, and rotation of the hollow cylindrical portion also forms the aperture in the wall or ceiling by cutting into the wall or ceiling.

22. The method of claim 20, wherein the body portion of the light fixture includes one or more receptacles adapted to receive portions of a drive tool, and wherein rotating the light fixture includes:
inserting portions of a drive tool into the receptacles in the body portion of the light fixture; and
rotating the drive tool to cause rotation of the light fixture.

23. A light fixture, comprising a body portion configured to receive a light engine and including a hollow cylindrical portion having means for retaining the light fixture relative to a structural member.

24. The light fixture of claim 23, wherein the retaining means include at least one thread extending around a surface of the hollow cylindrical portion.

25. The light fixture of claim 23, additionally including means for forming an aperture within a structural member.

26. The light fixture of claim 25, wherein the forming means include a serrated or sharp edge of the cylindrical portion.
